(19) United States
(12) Patent Application Publication
(10) Pub. No.: US 2024/0341328 A1
(43) Pub. Date: Oct. 17, 2024

(54) FUNCTIONAL COMPONENT-CONTAINING BEVERAGE FILLED IN SPRAYING CONTAINER

(71) Applicant: SUNTORY HOLDINGS LIMITED, Osaka (JP)

(72) Inventors: Tomoya Osada, Kanagawa (JP); Akira Soguchi, Kanagawa (JP); Yasuko Fujiwara, Kanagawa (JP)

(73) Assignee: SUNTORY HOLDINGS LIMITED, Osaka (JP)

(21) Appl. No.: 18/631,814

(22) Filed: Apr. 10, 2024

(30) Foreign Application Priority Data
Apr. 17, 2023 (JP) 2023-067099

(51) Int. Cl. A23L 2/38; A23L 2/56; B65D 83/14

(52) U.S. Cl. CPC A23L 2/38; A23L 2/56; B65D 83/14

(57) ABSTRACT

An object of the present invention is to provide a beverage with alleviated unpleasant taste derived from a functional component when drunk and with excellent quality stability and microorganism control. In the beverage, adjustment is made to satisfy conditions (a) to (c): (a) having a water activity of 0.94 or more; (b) containing a functional component; and (c) being filled in an aerosol type spraying container.

### TECHNICAL FIELD

The present invention relates to a beverage that contains a functional component, and more specifically, to a beverage in which unpleasant taste derived from a functional component is unlikely to be perceived when drunk.

### BACKGROUND ART

In many cases, supplements in the form of a tablet or a capsule are utilized as a means of ingesting a functional component at high efficiency. However, both tablets and capsules are absorbed only after being dissolved in the body, which poses a problem regarding absorbability. In addition, water is needed for drinking and swallowability is required as well.

As another means, nutritional drinks are used in some cases. However, nutritional drinks have disadvantages that they contain a large amount of extra sugars and components to improve the taste when drunk, and that they must be drunk every day, which is troublesome.

### SUMMARY OF INVENTION

### Technical Problem

To solve the above problems, liquid supplements with an even higher concentration of a functional component could be drunk directly; however, liquid supplements containing a functional component at a high concentration pose a problem in terms of flavor when drunk directly. Specifically, when a functional component is compounded at a high concentration, the beverage composition becomes unsuitable for drinking due to the bitterness, etc. peculiar to the functional component when drunk. Although diluting with water reduces the problem in terms of flavor, it is also troublesome when drunk, as a small amount must be transferred to a glass, etc.

In addition, in providing beverages, there are also problems in terms of quality stability and microorganism assurance after the container is opened. Specifically, after the container is opened, oxygen and light may alter the components contained in the beverages, changing the liquid color, and liquids for internal use with a high water activity may be easily contaminated by microorganisms.

Therefore, an object of the present invention is to provide a beverage with alleviated unpleasant taste derived from a functional component when drunk and with excellent quality stability and microorganism control.

### Solution to Problem

In attempting various means to solve the above problems, the present inventors turned their attention to the use of a spray bottle. As a result of diligent studies, the present inventors found that the unpleasant taste derived from a functional component can be mitigated by using a spray bottle equipped with a liquid atomizing attachment at the tip, filling the container with a beverage containing the functional component, and drinking it while injecting it in the form of mist.

On the other hand, the pump type spray bottle was found to pose problems such as a change in liquid color after the container is opened and insufficiency in terms of microorganism assurance. In response, the present inventors carried out diligent studies and found that the above problems can be solved by using an aerosol can out of spray bottles. Based on these findings, the present inventors completed the present invention.

That is, the present invention relates to, but is not limited to, the following.
(1) A beverage satisfying the following conditions (a) to (c):
(a) having a water activity of 0.94 or more;
(b) containing a functional component; and
(c) being filled in an aerosol type spraying container.
(2) The beverage according to (1), containing, as the functional component, any one or more of the following:
1 g/L or more of vitamin C;
0.5 g/L or more of γ-aminobutyric acid;
0.5 g/L or more of theanine;
0.5 g/L or more of cannabidiol;
0.5 g/L or more of caffeine;
1 g/L or more of citric acid; and
0.01 g/L or more of vitamin B1.
(3) The beverage according to (1) or (2), wherein an amount sprayed per use is 0.3 mL or more.
(4) The beverage according to any one of (1) to (3), wherein the aerosol type spraying container is a bag-on-valve (BOV).
(5) The beverage according to any one of (1) to (4), wherein a total content of monosaccharides and disaccharides, excluding sugar alcohols, is 20 g/L or less.
(6) The beverage according to any one of (1) to (5), containing a flavoring.

### Advantageous Effects of Invention

According to the present invention, there can be provided a beverage with alleviated unpleasant taste derived from a functional component when drunk and with excellent quality stability and microorganism control. By alleviating the unpleasant taste derived from a functional component, the overall flavor of the beverage is improved, making it easier to perceive the deliciousness of the beverage. By utilizing the beverage of the present invention, a liquid supplement containing a functional component at a high concentration can be drunk easily and with little unpleasant taste, and the functional component can be ingested at high efficiency. In addition, the beverage of the present invention is highly effective in terms of suppressing a change in liquid color and microorganism contamination, and the beverage can be easily ingested in a small amount by utilizing the aerosol type spraying container.

### DESCRIPTION OF EMBODIMENTS

Hereinafter, the present invention will be described. Note that, unless otherwise noted, “ppm,” “ppb,” and “% by weight” used herein refer to ppm, ppb, and % by weight in weight/volume (w/v), respectively.

One aspect of the present invention is a beverage satisfying the following conditions (a) to (c):
(a) having a water activity of 0.94 or more;
(b) containing a functional component; and
(c) being filled in an aerosol type spraying container.

### (Water Activity)

The beverage of the present invention has a water activity of 0.94 or more. In the present invention, the value of water activity can be adjusted by adjusting the amounts of various components contained in the beverage. Although the water activity of the beverage of the present invention is not particularly limited as long as it is 0.94 or more, it is preferably 0.95 or more, more preferably 0.96 or more, still more preferably 0.97 or more, and still more preferably 0.98 or more. In addition, the water activity of the beverage of the present invention is 1.0 or less. The water activity can be measured using a known water activity measuring apparatus, and for example, it can be measured using AquaLab 4TE (Meter Japan, Inc.). Note that the water activity in the beverage of the present invention is a water activity measured under the condition where the temperature of the beverage is 25° C.

### (Functional Component)

The beverage of the present invention contains a functional component. The functional component as used herein means a component that, when ingested orally into the human body, is absorbed into the body and generates a functional effect. Examples of the functional component include, but are not limited to, vitamin C, γ-aminobutyric acid, theanine, cannabidiol, caffeine, citric acid, and vitamin B1. In the present invention, only one functional component may be contained alone, or a combination of two or more functional components may be contained. The functional component may be a component contained in a raw material for the beverage, or it may be a refined product. In the present invention, the functional component used is preferably a commercially available refined product.

Vitamin C is a functional component that presents sour taste. Vitamin C is L-ascorbic acid, and its CAS Registration No. is 50-81-7. In the case where vitamin C is contained in the beverage, its content is, for example, 1 g/L or more, preferably 10 g/L or more, more preferably 25 g/L or more, and still more preferably 50 g/L or more. In the case where the content of vitamin C is 1 g/L or more, the sour taste of the beverage of the present invention tends to be alleviated when drunk. Although the upper limit value of the content of vitamin C is not particularly limited, it is, for example, 400 g/L or less, preferably 350 g/L or less, and more preferably 300 g/L or less. The content of vitamin C can be measured by known methods such as HPLC method.

γ-Aminobutyric acid is a functional component that presents bitter taste. γ-Aminobutyric acid is also called GABA, and its CAS Registration No. is 56-12-2. In the case where γ-aminobutyric acid is contained in the beverage, its content is, for example, 0.5 g/L or more, preferably 1 g/L or more, more preferably 5 g/L or more, and still more preferably 10 g/L or more. In the case where the content of γ-aminobutyric acid is 0.5 g/L or more, the bitter taste of the beverage of the present invention tends to be alleviated when drunk. Although the upper limit value of the content of γ-aminobutyric acid is not particularly limited, it is, for example, 200 g/L or less, preferably 100 g/L or less, and more preferably 50 g/L or less. The content of γ-aminobutyric acid can be measured by known methods such as HPLC method.

Theanine is a functional component that presents umami taste. In the present invention, L-theanine is preferably used, and its CAS Registration No. is 3081-61-6. In the case where theanine is contained in the beverage, its content is, for example, 0.5 g/L or more, preferably 1 g/L or more, more preferably 3 g/L or more, and still more preferably 5 g/L or more. In the case where the content of theanine is 0.5 g/L or more, the umami taste of the beverage of the present invention tends to be alleviated when drunk. Although the upper limit value of the content of theanine is not particularly limited, it is, for example, 150 g/L or less, preferably 100 g/L or less, and more preferably 50 g/L or less. The content of theanine can be measured by known methods such as HPLC method.

Cannabidiol is a functional component that presents bitter taste. The abbreviation for cannabidiol is CBD, and its CAS Registration No. is 13956-29-1. In the case where cannabidiol is contained in the beverage, its content is, for example, 0.5 g/L or more, preferably 1 g/L or more, more preferably 2 g/L or more, and still more preferably 3 g/L or more. In the case where the content of cannabidiol is 0.5 g/L or more, the bitter taste of the beverage of the present invention tends to be alleviated when drunk. Although the upper limit value of the content of cannabidiol is not particularly limited, it is, for example, 20 g/L or less, preferably 15 g/L or less, and more preferably 10 g/L or less. The content of cannabidiol can be measured by known methods such as HPLC method.

Caffeine is a functional component that presents bitter taste. Caffeine is known to be contained in coffee beverages and green tea beverages, and its CAS Registration No. is 58-08-2. In the case where caffeine is contained in the beverage, its content is, for example, 0.5 g/L or more, preferably 1 g/L or more, more preferably 2 g/L or more, and still more preferably 3 g/L or more. In the case where the content of caffeine is 0.5 g/L or more, the bitter taste of the beverage of the present invention tends to be alleviated when drunk. Although the upper limit value of the content of caffeine is not particularly limited, it is, for example, 100 g/L or less, preferably 50 g/L or less, and more preferably 30 g/L or less. The content of caffeine can be measured by known methods such as HPLC method.

Citric acid is a functional component that presents sour taste. Citric acid is a compound represented by the chemical formula C₆H₈O₇, and its CAS Registration No. is 77-92-9. In the case where citric acid is contained in the beverage, its content is, for example, 1 g/L or more, preferably 10 g/L or more, and more preferably 25 g/L or more. In the case where the content of citric acid is 1 g/L or more, the sour taste of the beverage of the present invention tends to be alleviated when drunk. Although the upper limit value of the content of citric acid is not particularly limited, it is, for example, 400 g/L or less, preferably 350 g/L or less, and more preferably 300 g/L or less. The content of citric acid can be measured by known methods such as HPLC method.

Vitamin B1 is a functional component that presents bitter taste. Vitamin B1 is thiamine, and the CAS Registration No. for its hydrochloride salt is 67-03-8. In the case where vitamin B1 is contained in the beverage, its content is, for example, 0.01 g/L or more, preferably 0.05 g/L or more, more preferably 0.25 g/L or more, and still more preferably 0.5 g/L or more. In the case where the content of vitamin B1 is 0.01 g/L or more, the bitter taste of the beverage of the present invention tends to be alleviated when drunk. Although the upper limit value of the content of vitamin B1 is not particularly limited, it is, for example, 3.5 g/L or less, preferably 3.0 g/L or less, and more preferably 2.5 g/L or less. The content of vitamin B1 can be measured by known methods such as HPLC method.

### (Monosaccharides and Disaccharides)

In the beverage of the present invention, the total content of monosaccharides and disaccharides, excluding sugar alcohols, may be 20 g/L or less. In this way, the sweet taste peculiar to the monosaccharides and disaccharides, excluding sugar alcohols, can be reduced. In addition, by reducing the total content of the monosaccharides and disaccharides, excluding sugar alcohols, the calories originating from those sugars can be suppressed, and the ability to control microorganism growth in the beverage can also be enhanced.

In the beverage of the present invention, the total content of the monosaccharides and disaccharides, excluding sugar alcohols, is preferably 15 g/L or less, more preferably 10 g/L or less, still more preferably 5 g/L or less, and most preferably 0 g/L (that is, no monosaccharides and disaccharides, excluding sugar alcohols, are contained). Although the monosaccharides, excluding sugar alcohols, are not particularly limited, specific examples thereof may include glucose, fructose, D-xylose, and L-arabinose. In addition, specific examples of the disaccharides, excluding sugar alcohols, may include, but are not limited to, sucrose and lactose.

In the beverage of the present invention, the total content of the monosaccharides and disaccharides, excluding sugar alcohols, can be measured by known methods such as HPLC method.

### (Flavoring)

The beverage of the present invention may contain a flavoring. The flavoring as used herein means a substance that can impart fragrance or taste to the target beverage. In the present invention, it is particularly preferable to use a flavoring composition in which several refined aroma components are compounded. In the case where a flavoring is compounded in the beverage of the present invention, by injecting the beverage directly into the mouth from the spraying container, the beverage will be more fragrant. This is presumably due to increased volatility of the aroma components in the flavoring as a result of the beverage being sprayed and dispensed. This effectively alleviates unpleasant taste derived from a functional component.

Although the flavoring is not particularly limited, for example, one containing a terpene compound or an ester compound as an aroma component is used. Examples of the terpene compound include, but are not limited to, linalool, limonene, α-terpineol, and octanal. Examples of the ester compound include, but are not limited to, ethyl isovalerate, isoamyl acetate, isoamyl butyrate, and ethyl butyrate.

In addition, examples of the flavoring include, but are not limited to, a lemon flavoring, a lime flavoring, a plum flavoring, a strawberry flavoring, an apple flavoring, an orange flavoring, a grapefruit flavoring, a grape flavoring, a jasmine flavoring, a fruit mix flavoring, a coffee flavoring, and a mint flavoring. These flavorings mean flavoring compositions that present aromas that are associated with various fragrances when drunk or eaten (for example, in the case of a lemon flavoring, the aroma that is associated with the fragrance of lemon).

The content of the flavoring in the beverage of the present invention is, for example, 1 ml/L or more, preferably 2 ml/L or more, and more preferably 3 ml/L or more. Although the upper limit value of the flavoring is not particularly limited, it is, for example, 50 ml/L or less, preferably 30 ml/L or less, and more preferably 10 ml/L or less.

### (Other Components)

In the beverage of the present invention, various additives and the like may be compounded, as in ordinary beverages, to the extent that the effects of the present invention are not hindered. Examples of the various additives may include an antioxidant, an emulsifier, a preservative, an extract, a dietary fiber, a pH adjusting agent, and a quality stabilizer.

### (Degree of Sweet Taste)

The beverage of the present invention may have a degree of sweet taste of 1 to 30. In the present invention, the degree of sweet taste is an index representing the sweet taste of a beverage, where the sweetness of a beverage containing 1 g of sucrose in 100 g of the beverage is defined as “1”. The degree of sweet taste of a beverage is determined by converting the content of each sweet taste component into the equivalent amount of sucrose based on the relative ratio of the sweet taste of that sweet taste component to the sweet taste of sucrose, 1, and then summing up the sucrose sweet taste equivalents of all sweet taste components (including sweet taste components derived from fruit juices, extracts, etc.) contained in the beverage. For the degree of sweet taste of a sweet taste component relative to sucrose, the degree of sweet taste provided by the manufacturer that produces or sells that sweet taste component, or the degree of sweet taste obtained through sensory evaluation can be utilized.

In the present invention, the degree of sweet taste of the beverage is preferably 1 to 20, and more preferably 1 to 15. The degree of sweet taste of the beverage can be adjusted using a sweet taste component. As the sweet taste component, for example, sweet taste components ordinarily used in the beverage field can be used, but sweet taste components used outside the beverage field may also be used. In the present invention, a sweet taste component may be compounded directly into the beverage as a sweetener, or a fruit juice, an extract, etc. containing a sweet taste component may be compounded.

The preferred sweet taste component in the beverage of the present invention is a sugar alcohol. Examples of the sugar alcohol include, but are not limited to, a monosaccharide alcohol such as xylitol, erythritol, sorbitol, and mannitol; a disaccharide alcohol such as maltitol, isomaltitol, and lactitol; a trisaccharide alcohol such as maltotriitol, isomaltotriitol, and panitol; a tetra- or higher-saccharide alcohol such as an oligosaccharide alcohol; and a powdered reduced maltose syrup. The preferred sugar alcohol used in the present invention is a monosaccharide alcohol, of which xylitol, erythritol, and sorbitol are more preferable. In the beverage of the present invention, these sugar alcohols may be used alone, or a combination of two or more sugar alcohols may be used.

The content of the sugar alcohol in the beverage of the present invention can be set depending on the degree of sweet taste of the beverage and the type of the sugar alcohol, as described above. In other words, the sugar alcohol can be contained in the beverage of the present invention in such an amount that the degree of sweet taste of the beverage is 1 to 30, preferably 1 to 20, and more preferably 1 to 15.

Also, in the case where the sugar alcohol is xylitol, the content in the beverage of the present invention is preferably 10 to 300 g/L, more preferably 10 to 200 g/L, and still more preferably 10 to 150 g/L.

In the case where the sugar alcohol is erythritol, the content in the beverage of the present invention is preferably 12 to 370 g/L, more preferably 12 to 250 g/L, and still more preferably 12 to 190 g/L.

In the case where the sugar alcohol is sorbitol, the content in the beverage of the present invention is preferably 16 to 500 g/L, more preferably 16 to 333 g/L, and still more preferably 16 to 250 g/L.

The content of the sugar alcohol compounded in the beverage of the present invention can be measured by known methods such as HPLC method.

In addition to the sugar alcohol described above, the preferred sweet taste component in the beverage of the present invention is a high intensity sweetener. The high intensity sweetener means a sweetener that has sweet taste 10 to 10,000 times that of sugar (sucrose). As the high intensity sweetener used in the present invention, any high intensity sweetener, both natural sweeteners and synthetic sweeteners, can be used. Specific examples of the type of the high intensity sweetener include, but are not limited to, sucralose, acesulfame potassium, aspartame, stevia (rebaudioside, stevioside), somatin, saccharin, sodium saccharin, licorice, Momordica grosvenori, neotame, mabinlin, brazzein, monellin, glycyrrhizin, alitame, sodium N-cyclohexylsulfamate, dulcin, and neohesperidin. The preferred high intensity sweeteners used in the present invention are acesulfame potassium and sucralose. In the beverage of the present invention, one of these high intensity sweeteners or two or more of them can be used. In the beverage of the present invention, the high intensity sweetener can also be compounded in combination with a sugar alcohol.

The content of the high intensity sweetener in the beverage of the present invention can be set depending on the degree of sweet taste of the beverage and the type of the high intensity sweetener, as described above. In other words, the high intensity sweetener can be contained in the beverage of the present invention in such an amount that the degree of sweet taste of the beverage is 1 to 30, preferably 1 to 20, and more preferably 1 to 15.

Also, in the case where the high intensity sweetener is sucralose, the content in the beverage of the present invention is preferably 16 to 500 mg/L, more preferably 16 to 333 mg/L, and still more preferably 16 to 250 mg/L.

In the case where the high intensity sweetener is acesulfame potassium, the content in the beverage of the present invention is preferably 50 to 1500 mg/L, more preferably 50 to 1000 mg/L, and still more preferably 50 to 750 mg/L.

The content of the high intensity sweetener compounded in the beverage of the present invention can be measured by known methods such as HPLC method.

### (Acidity)

The beverage of the present invention may have an acidity of 0.005 to 6.0. In the present invention, the acidity is a value that serves as an index of acid content, and can be determined by calculation from, when an alkali such as sodium hydroxide is added to a certain amount of beverage (sample) for neutralization, the amount of the alkali required for neutralization (pH 7.0). For acidity measurement, an autotitrator (Kyoto Electronics Manufacturing Co., Ltd., AT-710/CHA-700, etc.) can be used. In the present invention, the acidity used is the value converted to the amount of citric acid (determined by calculation from the neutralization amount, assuming that all the acid contained in the beverage is citric acid). Also, the unit of acidity in the present invention is “g/100 mL”.

In the present invention, the acidity of the beverage is preferably 0.01 to 6, and more preferably 0.05 to 5. The acidity of the beverage of the present invention may be adjusted using any acid. For example, the acidity of the beverage can be adjusted using, but not limited to, phosphoric acid, tartaric acid, malic acid, oxalic acid, gluconic acid, ascorbic acid, succinic acid, lactic acid, acetic acid, sulfuric acid, hydrochloric acid, fumaric acid, phytic acid, itaconic acid, or other acids. In the present invention, the acidity can also be adjusted by using a fruit juice (this may be either clear fruit juice or cloudy fruit juice), a food additive standard acidulant, etc.

The content of the acid in the beverage of the present invention can be set depending on the acidity of the beverage and the type of the acid, as described above. In other words, the acid can be contained in the beverage of the present invention in such an amount that the acidity of the beverage is 0.005 to 6.0, preferably 0.01 to 6, and more preferably 0.05 to 5.

(pH)

Although the pH of the beverage of the present invention is not particularly limited, it is, for example, pH 2.0 to 6.0, preferably pH 2.5 to 5.0, and more preferably pH 3.0 to 4.6. Examples of the pH adjusting agent include trisodium citrate, sodium carbonate, sodium hydrogen carbonate, disodium hydrogen phosphate, and potassium carbonate, but in particular, trisodium citrate is most preferable in the present invention.

### (Brix)

Although the Brix of the beverage of the present invention is not particularly limited, it is, for example, 0.2 or more, preferably 1 or more, and more preferably 2 or more. Also, as the upper limit value, the Brix of the beverage of the present invention is, for example, 30 or less, and preferably 25 or less. The Brix can be evaluated according to the Brix value obtained using a saccharimeter or a refractometer. The Brix value is the value obtained by converting the refractive index measured at 20° C. into mass/mass percent of sucrose solution according to the ICUMSA (International Commission for Uniform Methods of Sugar Analysis) conversion table. The unit is shown in “°Bx”, “%”, or “degree”.

### (Beverage)

The type of the beverage of the present invention is not particularly limited, and can be, for example, a refreshing beverage. The beverage of the present invention may be, for example, any of the following: a nutritional beverage, a functional beverage, a liquid supplement, a flavored water (near water) beverage, a tea beverage (black tea, oolong tea, green tea, etc.), and a coffee beverage. Also, the beverage of the present invention may be a beverage containing carbon dioxide gas (that is, carbonated beverage), or may be a beverage that does not contain carbon dioxide gas (that is, non-carbonated beverage).

### (Aerosol Type Spraying Container)

The beverage of the present invention is characterized by being filled in an aerosol type spraying container. That is, the beverage of the present invention is a beverage packaged in a container, and more specifically, a beverage packaged in an aerosol type spraying container. The aerosol type spraying container may be a container that sprays the contents manually (manual container), or may be a container that sprays the contents by an electric machine (electric container). Also, the aerosol type spraying container may be a single spraying container that sprays a predetermined amount of the contents in a single dispensing operation, or may be a continuous spraying container that continuously and persistently sprays the contents while the dispensing operation is carried out (for example, while the actuator part of the spraying container is continuously operated).

In the aerosol type spraying container, known spraying gases that can be utilized in conventional aerosol products can be used as the propellant, and for example, compressed gases of nitrous oxide gas, nitrogen gas, carbon dioxide gas, etc. can be used. Liquefied gases such as liquefied petroleum gas (LPG) and dimethyl ether (DME) can also be used. Although the spray pressure of the aerosol type spraying container is not limited, the spray pressure at 20° C. is, for example, 0.05 to 1.5 MPa, and preferably 0.1 to 1.0 MPa.

In the case where a propellant is used in the present invention, the beverage filled in a spraying container can be produced by preparing the contents (beverage) not containing the propellant, mixing the contents with the propellant, and filling the container with the mixture. Although the content ratio between the contents (beverage) and the propellant is not particularly limited in the present invention, it is, for example, 10:90 to 60:40, and preferably 20:80 to 50:50, in volume ratio.

In addition, for the aerosol type spraying container, a bag-on-valve (BOV) can also be used. The bag-on-valve is an aerosol type container in which the interior of the container is divided into the following two layers: propellant chamber and content (beverage) chamber, by a barrier material (aluminum pouch, etc.) fixed at the bottom of the aerosol valve. The bag-on-valve is characterized by the dual structure of the propellant chamber and the content (beverage) chamber, which prevents the propellant (gas, etc.) from coming into direct contact with the contents, thereby preventing oxidation and alteration of the contents. In addition, the characteristic that spray occurs only when the aerosol can is pressed makes it possible to reduce or adjust the amount used. For the bag-on-valve, those commercially available can be used. In the present invention, a bag-on-valve is preferably used as the aerosol type spraying container.

For the beverage of the present invention, the amount sprayed per use by the aerosol type spraying container is, for example, 0.3 mL or more, preferably 0.4 mL or more, and more preferably 0.5 mL or more. For the aerosol type spraying container used in the present invention, although not particularly limited, the amount sprayed in 0.5 seconds is preferably 0.3 mL or more (the amount sprayed in 1 second is 0.6 mL or more), the amount sprayed in 0.5 seconds is more preferably 0.4 mL or more (the amount sprayed in 1 second is 0.8 mL or more), and the amount sprayed in 0.5 seconds is still more preferably 0.5 mL or more (the amount sprayed in 1 second is 1 mL or more). In the present invention, the amount sprayed herein means the amount of the contents sprayed from the spraying container. Although not particularly limited, the aerosol type spraying container in the present invention is preferably used to spray the contents for 0.5 seconds or longer, more preferably used to spray the contents for 1 second or longer, and still more preferably used to spray the contents for 2 seconds or longer. Although the duration of use of the aerosol type spraying container in the present invention is not particularly limited, it is, for example, 10 seconds or shorter.

The beverage of the present invention can be drunk by injecting it directly into the mouth from the spraying container. The amount of the beverage of the present invention sprayed can be calculated using the difference in weight of the contents before and after the injection and the specific gravity of the contents. In addition, although the amount of the beverage of the present invention filled inside the container is not particularly limited, it is, for example, 10 to 500 mL, preferably 20 to 400 mL, and more preferably 30 to 300 mL.

In an aspect, the present invention is a method for producing a beverage filled in an aerosol type spraying container. More specifically, one aspect of the present invention is a method for producing a beverage, the method including:
(a) a step of adjusting the water activity of a beverage to 0.94 or more;
(b) a step of compounding a functional component; and
(c) a step of filling an aerosol type spraying container with the beverage.

The beverage of the present invention may be produced by compounding the various components described above as appropriate, or by adjusting their content in the beverage. That is, the production method of the present invention can include a step of compounding the components described above and a step of adjusting the content of such components in the beverage. There is no particular limitation on the order in which the components are compounded. In addition, the production method of the present invention can also include a step of adjusting the degree of sweet taste of the beverage, a step of adjusting the acidity, a step of adjusting the pH, a step of adjusting the Brix value, etc. In the production method of the present invention, each step other than the beverage filling step may be carried out in any order, as long as the various conditions, etc. in the beverage finally obtained are within the required ranges. Note that the various elements in the beverage production of the present invention, such as the type of components in the beverage and their content, are as described above for the beverage of the present invention, or are obvious from the description thereof.

In addition, the method for producing a beverage of the present invention may include a step of subjecting the beverage to heat sterilization, if necessary. For example, a sterilized beverage packaged in an aerosol type spraying container can be produced by a method in which heat sterilization, etc. is carried out after the beverage is filled into the aerosol type spraying container, or by a method in which the beverage is sterilized and then filled into the aerosol type spraying container in an aseptic environment. The heat sterilization treatment can be carried out according to local regulations (in Japan, the Food Sanitation Act), for example. Specific examples thereof include a method in which the beverage is sterilized at a high temperature for a short time and then filled into a storage container that has been subjected to a sterilization treatment under aseptic conditions (UHT sterilization method), and a retort sterilization method in which the preparation liquid is filled into a storage container and then subjected to a retort treatment. In the case of the UHT sterilization method, the conditions are ordinarily 70 to 150° C. for 1 to 60 seconds, and preferably 80 to 130° C. for 1 to 30 seconds, and in the case of the retort sterilization method, the conditions are ordinarily 70 to 150° C. for 1 to 30 minutes, and preferably 80 to 140° C. for 1 to 10 minutes.

### EXAMPLES

Hereinafter, the details of the present invention will be specifically described by means of experimental examples, but the present invention is not limited to them. Also, in the present specification, unless otherwise stated, numerical ranges are described as including their end points.

### Experimental Example 1

Using vitamin C (San-Ei Gen F.F.I., Inc.), theanine (Taiyo Kagaku Co., Ltd.), GABA (Pharma Foods International Co., Ltd.), Vitamin MIX (San-Ei Gen F.F.I., Inc.), water soluble CBD (Kitchodo Co., Ltd.), caffeine (Maruzen Chemicals Co., Ltd.), and citric acid (San-Ei Gen F.F.I., Inc.) as functional components, beverage samples containing the various functional components were prepared as shown in the table below. Vitamin MIX was a mixture of vitamin B1, vitamin B2, vitamin B6, vitamin B12, niacin, and pantothenic acid, and 5 w/w % of the entire weight was vitamin B1. The content of the functional components in the beverage samples was adjusted to various contents depending on the evaluation test. 30 mL of the various beverages obtained were poured into plastic cups. In the case where the beverage samples were drunk without injection, the beverage samples poured into the cups were used as they were. On the other hand, in the case where the beverage samples were injected for drinking, the tube part of a pump type nozzle (dispenser) (Mitani Valve Co., Ltd., Z-500-C038), which is capable of spraying 0.5 mL per push, was inserted into the beverages poured into the cups, thereby preparing beverages in a pump type spraying container.

The water activity of the prepared beverage samples was measured using the water activity measuring apparatus AquaLab 4TE (Meter Japan, Inc.) under conditions of 25° C. As a result, the water activity of the beverage samples with the highest concentration of functional components was 0.961 (300 g/L) for vitamin C-containing beverages, 0.982 (100 g/L) for theanine-containing beverages, 0.979 (100 g/L) for GABA-containing beverages, 0.975 (2.5 g/L) for vitamin B1-containing beverages, 0.968 (20 g/L) for CBD-containing beverages, 0.990 (30 g/L) for caffeine-containing beverages, and 0.965 (300 g/L) for citric acid-containing beverages. In addition, from these results, other beverage samples containing the various functional components were considered to exhibit values equal to or higher than the water activities described above.

TABLE 1
Vitamin C-containing beverage

| | | |
|---|---|---|
| Xylitol | 50 | g |
| Trisodium citrate | 10 | g |
| Vitamin C | X | g |
| Lemon flavoring | 10 | ml |
| Total | 1 | L |

GABA-containing beverage

| | | |
|---|---|---|
| Xylitol | 30 | g |
| Jasmine tea powder | 1 | g |
| GABA | X | g |
| Citric anhydride | 3 | g |
| Jasmine flavoring | 10 | ml |
| Total | 1 | L |

CBD-containing beverage

| | | |
|---|---|---|
| Xylitol | 100 | g |
| CBD | X | g |
| Citric anhydride | 5 | g |
| Coffee flavoring | 10 | ml |
| Total | 1 | L |

Citric acid-containing beverage

| | | |
|---|---|---|
| Xylitol | 10 | g |
| Citric anhydride | X | g |
| Lemon flavoring | 10 | ml |
| Total | 1 | L |

Theanine-containing beverage

| | | |
|---|---|---|
| Xylitol | 30 | g |
| Jasmine tea powder | 1 | g |
| Theanine | X | g |
| Citric anhydride | 3 | g |
| Jasmine flavoring | 10 | ml |
| Total | 1 | L |

Vitamin B1-containing beverage

| | | |
|---|---|---|
| Xylitol | 100 | g |
| Vitamin B1 | X | g |
| Citric anhydride | 10 | g |
| Fruit mix flavoring | 10 | ml |
| Total | 1 | L |

Caffeine-containing beverage

| | | |
|---|---|---|
| Xylitol | 20 | g |
| Caffeine | X | g |
| Citric anhydride | 1 | g |
| Mint flavoring | 10 | ml |
| Total | 1 | L |

In addition, the following numerical values were obtained for the beverages containing the various functional components.

TABLE 2

| | Vitamin C | Theanine | GABA | Vitamin B1 | CBD | Caffeine | Citric acid |
|---|---|---|---|---|---|---|---|
| Value of X | 100 | 8 | 30 | 0.5 | 4 | 6 | 100 |
| Water | 0.968 | 0.986 | 0.981 | 0.977 | 0.973 | 0.991 | 0.971 |
| activity | | | | | | | |
| pH | 3.3 | 3.6 | 4.3 | — | — | — | — |
| Brix | 22 | 5.5 | 5.5 | — | — | — | — |
| Degree of | 50 | 30 | 30 | 100 | 100 | 20 | 10 |
| sweet taste | | | | | | | |

For the above beverage samples, sensory evaluation tests were carried out. In the case where the beverage samples were drunk without injection, 1 mL of the beverage samples were drunk as they were, using a spoon. On the other hand, in the case where the beverage samples were injected for drinking, the beverages in a pump type spraying container described above were used to inject them into the mouths of the evaluators by quickly pushing twice.

As for the sensory evaluation, two expert panelists carried out evaluation of the taste and fragrance presented by the functional components of the various beverages. In addition, overall evaluation of the various beverage samples was also carried out. Each expert panelist carried out 5-point evaluation according to the following criteria, and their average score was used as the evaluation score.

### <Sour Taste>

5 points: Very strong sour taste perceived.
4 points: Strong sour taste perceived.
3 points: Sour taste perceived.
2 points: A little sour taste perceived.
1 point: Almost no sour taste perceived.

### <Umami Taste>

5 points: Very strong umami taste perceived.
4 points: Strong umami taste perceived.
3 points: Umami taste perceived.
2 points: A little umami taste perceived.
1 point: Almost no umami taste perceived.

### <Bitter Taste>

5 points: Very strong bitter taste perceived.
4 points: Strong bitter taste perceived.
3 points: Bitter taste perceived.
2 points: A little bitter taste perceived.
1 point: Almost no bitter taste perceived.

### <Fragrance>

5 points: Very strong fragrance perceived.
4 points: Strong fragrance perceived.
3 points: Fragrance perceived.
2 points: A little fragrance perceived.
1 point: Almost no fragrance perceived.

### <Overall Evaluation>

5 points: Very delicious.
4 points: Delicious.
3 points: Slightly delicious.
2 points: Not so delicious.
1 point: Not delicious.

TABLE 3-1
Vitamin C-containing beverage

| | Drunk without injection | | | Drunk with injection (sprayed) | | | Degree of |
|---|---|---|---|---|---|---|---|
| Value | Sour | | Overall | Sour | | Overall | effectiveness |
| of X | taste | Fragrance | evaluation | taste | Fragrance | evaluation | of spraying |
| 10 | 1 | 3 | 4 | 1 | 5 | 5 | 1 |
| 25 | 2 | 3 | 3 | 1 | 5 | 5 | 2 |
| 50 | 3 | 3 | 2 | 2 | 5 | 5 | 3 |
| 100 | 4 | 3 | 1.5 | 2 | 5 | 4 | 2.5 |
| 200 | 5 | 3 | 1 | 3 | 5 | 3.5 | 2.5 |
| 300 | 5 | 3 | 1 | 3 | 5 | 3.5 | 2.5 |

TABLE 3-2
Theanine-containing beverage

| | Drunk without injection | | | Drunk with injection (sprayed) | | | Degree of |
|---|---|---|---|---|---|---|---|
| Value | Umami | | Overall | Umami | | Overall | effectiveness |
| of X | taste | Fragrance | evaluation | taste | Fragrance | evaluation | of spraying |
| 1 | 1 | 3 | 4 | 1 | 5 | 5 | 1 |
| 3 | 2 | 3 | 3 | 1 | 5 | 5 | 2 |
| 5 | 2.5 | 3 | 2.5 | 1.5 | 5 | 5 | 2.5 |
| 10 | 3 | 3 | 2 | 2 | 5 | 5 | 3 |
| 30 | 4 | 3 | 1.5 | 2 | 5 | 4 | 2.5 |
| 50 | 5 | 3 | 1 | 3 | 5 | 3 | 2 |
| 100 | 5 | 3 | 1 | 3 | 5 | 2.5 | 1.5 |

TABLE 3-3
GABA-containing beverage

| | Drunk without injection | | | Drunk with injection (sprayed) | | | Degree of |
|---|---|---|---|---|---|---|---|
| Value | Bitter | | Overall | Bitter | | Overall | effectiveness |
| of X | taste | Fragrance | evaluation | taste | Fragrance | evaluation | of spraying |
| 1 | 1 | 3 | 4 | 1 | 5 | 5 | 1 |
| 5 | 1 | 3 | 3 | 1 | 5 | 5 | 2 |
| 10 | 2 | 3 | 2 | 1 | 5 | 5 | 3 |
| 30 | 3 | 3 | 1.5 | 1.5 | 5 | 4 | 2.5 |
| 50 | 4 | 3 | 1 | 2 | 5 | 3.5 | 2.5 |
| 100 | 5 | 3 | 1 | 3 | 5 | 2 | 1 |

TABLE 3-4
Vitamin B1-containing beverage

| | Drunk without injection | | | Drunk with injection (sprayed) | | | Degree of |
|---|---|---|---|---|---|---|---|
| Value | Bitter | | Overall | Bitter | | Overall | effectiveness |
| of X | taste | Fragrance | evaluation | taste | Fragrance | evaluation | of spraying |
| 0.05 | 2 | 3 | 4 | 1 | 5 | 5 | 1 |
| 0.25 | 3 | 3 | 3 | 1.5 | 5 | 5 | 2 |
| 0.5 | 4 | 3 | 2 | 2.5 | 5 | 5 | 3 |
| 1.25 | 4.5 | 3 | 1.5 | 3 | 5 | 4 | 2.5 |
| 2.5 | 5 | 3 | 1 | 4 | 5 | 3.5 | 2.5 |

TABLE 3-5
CBD-containing beverage

| | Drunk without injection | | | Drunk with injection (sprayed) | | | Degree of |
|---|---|---|---|---|---|---|---|
| Value | Bitter | | Overall | Bitter | | Overall | effectiveness |
| of X | taste | Fragrance | evaluation | taste | Fragrance | evaluation | of spraying |
| 1 | 2 | 3 | 4 | 1 | 5 | 5 | 1 |
| 3 | 3 | 3 | 3 | 2 | 5 | 5 | 2 |
| 5 | 4 | 3 | 2 | 2.5 | 5 | 4 | 2 |
| 10 | 5 | 3 | 1.5 | 3 | 5 | 3 | 1.5 |
| 20 | 5 | 3 | 1 | 4 | 5 | 2 | 1 |

TABLE 3-6
Caffeine-containing beverage

| | Drunk without injection | | | Drunk with injection (sprayed) | | | Degree of |
|---|---|---|---|---|---|---|---|
| Value | Bitter | | Overall | Bitter | | Overall | effectiveness |
| of X | taste | Fragrance | evaluation | taste | Fragrance | evaluation | of spraying |
| 1 | 1 | 3 | 4.5 | 1 | 5 | 5 | 0.5 |
| 3 | 2 | 3 | 3.5 | 1.5 | 5 | 4.5 | 1 |
| 5 | 3 | 3 | 3 | 2.5 | 5 | 4 | 1 |
| 10 | 4 | 3 | 2 | 3.5 | 5 | 3 | 1 |
| 30 | 5 | 3 | 1 | 4.5 | 5 | 2 | 1 |

TABLE 3-7
Citric acid-containing beverage

| | Drunk without injection | | | Drunk with injection (sprayed) | | | Degree of |
|---|---|---|---|---|---|---|---|
| Value | Sour | | Overall | Sour | | Overall | effectiveness |
| of X | taste | Fragrance | evaluation | taste | Fragrance | evaluation | of spraying |
| 10 | 1 | 3 | 4.5 | 1 | 5 | 5 | 0.5 |
| 25 | 2 | 3 | 4 | 1 | 5 | 4.5 | 0.5 |
| 50 | 3 | 3 | 3 | 2 | 5 | 3.5 | 0.5 |
| 100 | 4 | 3 | 2.5 | 2 | 5 | 3 | 0.5 |
| 200 | 5 | 3 | 2 | 3 | 5 | 2.5 | 0.5 |
| 300 | 5 | 3 | 1.5 | 3 | 5 | 2 | 0.5 |

The results were as described above, and it was found that the unpleasant tastes derived from the functional components were mitigated in the case where the beverage samples were drunk by injection using the spraying container, compared to the case where the beverage samples were drunk without injection.

### Experimental Example 2

Whether the above results could be similarly obtained even in the case of using an aerosol type spraying container was checked. For the beverage samples prepared in the above experimental example, one beverage sample was selected for each type of functional component, and 60 mL of each was filled into an aerosol can (BOV (60 mL) manufactured by Mitani Valve Co., Ltd., initial internal pressure 0.6 MPa). A sensory evaluation test was carried out for the obtained beverages in the aerosol type spraying container.

In the sensory evaluation test, the amount sprayed from the aerosol can was thoroughly checked beforehand, and the beverages were injected into the mouths of the evaluators, adjusting the amount of the beverages injected into the mouths to about 1 mL. After injection into the mouths, the amount of weight loss of the beverages in the aerosol type spraying container was examined to ensure that the amount sprayed was within the range of 1 mL to 1.05 mL. Note that the injection time of the aerosol can was about 1 second.

As for the sensory evaluation, two expert panelists carried out evaluation of the taste and fragrance presented by the functional components of the various beverages. In addition, overall evaluation of the various beverage samples was also carried out. The sensory evaluation was carried out using the same criteria as in Experimental Example 1 above, and the average score was used as the evaluation score.

TABLE 4-1
Vitamin C-containing beverage

| | Drunk without injection | | | Drunk with injection (sprayed) | | |
|---|---|---|---|---|---|---|
| Value | Sour | | Overall | Sour | | Overall |
| of X | taste | Fragrance | evaluation | taste | Fragrance | evaluation |
| 100 | 4 | 3 | 1.5 | 2 | 5 | 4 |

TABLE 4-2
Theanine-containing beverage

| | Drunk without injection | | | Drunk with injection (sprayed) | | |
|---|---|---|---|---|---|---|
| Value | Umami | | Overall | Umami | | Overall |
| of X | taste | Fragrance | evaluation | taste | Fragrance | evaluation |
| 10 | 3 | 3 | 2 | 2 | 5 | 5 |

TABLE 4-3
GABA-containing beverage

| | Drunk without injection | | | Drunk with injection (sprayed) | | |
|---|---|---|---|---|---|---|
| Value | Bitter | | Overall | Bitter | | Overall |
| of X | taste | Fragrance | evaluation | taste | Fragrance | evaluation |
| 30 | 3 | 3 | 1.5 | 1.5 | 5 | 4 |

TABLE 4-4
Vitamin B1-containing beverage

| | Drunk without injection | | | Drunk with injection (sprayed) | | |
|---|---|---|---|---|---|---|
| Value | Bitter | | Overall | Bitter | | Overall |
| of X | taste | Fragrance | evaluation | taste | Fragrance | evaluation |
| 0.5 | 4 | 3 | 2 | 2.5 | 5 | 5 |

TABLE 4-5
CBD-containing beverage

| | Drunk without injection | | | Drunk with injection (sprayed) | | |
|---|---|---|---|---|---|---|
| Value | Bitter | | Overall | Bitter | | Overall |
| of X | taste | Fragrance | evaluation | taste | Fragrance | evaluation |
| 5 | 4 | 3 | 2 | 2.5 | 5 | 4 |

TABLE 4-6
Caffeine-containing beverage

| | Drunk without injection | | | Drunk with injection (sprayed) | | |
|---|---|---|---|---|---|---|
| Value | Bitter | | Overall | Bitter | | Overall |
| of X | taste | Fragrance | evaluation | taste | Fragrance | evaluation |
| 5 | 3 | 3 | 3 | 2.5 | 5 | 4 |

TABLE 4-7
Citric acid-containing beverage

| | Drunk without injection | | | Drunk with injection (sprayed) | | |
|---|---|---|---|---|---|---|
| Value | Sour | | Overall | Sour | | Overall |
| of X | taste | Fragrance | evaluation | taste | Fragrance | evaluation |
| 50 | 3 | 3 | 3 | 2 | 5 | 3.5 |

The results were as described above, and similarly, in the case of using the aerosol type spraying container, it was found that the unpleasant tastes derived from the functional components were mitigated in the case where the beverage samples were drunk by injection using the spraying container, compared to the case where the beverage samples were drunk without injection.

### Experimental Example 3

Beverages in a pump type spraying container and beverages in an aerosol type spraying container were prepared, and stability evaluation was performed with the number of tests being N=5. A commercially available refillable pump type spray bottle (AutoGo Spray Bottle 100 ml) was used as the pump type spraying container, which was filled with 60 ml of the functional component-containing beverage samples. The beverages in an aerosol type spraying container were prepared in the same manner as in Experimental Example 2.

The various beverages were immersed in hot water while being filled in the containers, and subjected to a sterilization treatment at 80° C. for 1 minute. Thereafter, the various beverages were stored at 28° C., and 2 mL was injected into the mouth every 3 days. Quality evaluation was performed two weeks after the initiation of the test. As the quality evaluation, a change in liquid color, occurrence of mold, and the flavor of the beverage were checked. Note that beverages in which mold flocs were observed during the test were not injected into the mouth.

TABLE 5

| | | Pump type spray bottle | | | Aerosol type spraying container | | |
|---|---|---|---|---|---|---|---|
| Functional | Value | Liquid | | | Liquid | | |
| component | of X | color | Mold, yeast | Flavor | color | Mold, yeast | Flavor |
| Vitamin C | 100 | Changed | 0 flocs/ml | Strong smell of | No | 0 flocs/ml | No |
| | | to brown | | deterioration | change | | significant |
| | | | | perceived | | | change |
| Theanine | 10 | No change | Mold flocs | Fragrance | No | 0 flocs/ml | No |
| | | | visually | weakened | change | | significant |
| | | | observed in | Beverage with | | | change |
| | | | one bottle | flocs was not | | | |
| | | | | injected | | | |
| GABA | 30 | No change | Mold flocs | Fragrance | No | 0 flocs/ml | No |
| | | | visually | weakened | change | | significant |
| | | | observed in | Beverage with | | | change |
| | | | one bottle | flocs was not | | | |
| | | | | injected | | | |
| Vitamin B1 | 0.5 | No change | Mold flocs | Fragrance | No | 0 flocs/ml | No |
| | | | visually | weakened | change | | significant |
| | | | observed in | Beverage with | | | change |
| | | | one bottle | flocs was not | | | |
| | | | | injected | | | |

The results were as described above, and it was found that the beverages in an aerosol type spraying container were superior to the beverages in a pump type spraying container in terms of a change in liquid color, occurrence of mold, and the flavor of the beverage.

What is claimed is:

1. A beverage satisfying the following conditions (a) to (c):
(a) having a water activity of 0.94 or more;
(b) comprising a functional component; and
(c) being filled in an aerosol type spraying container.

2. The beverage according to claim 1, comprising, as the functional component, any one or more of the following: 1 g/L or more of vitamin C; 0.5 g/L or more of γ-aminobutyric acid; 0.5 g/L or more of theanine; 0.5 g/L or more of cannabidiol; 0.5 g/L or more of caffeine; 1 g/L or more of citric acid; and 0.01 g/L or more of vitamin B1.

3. The beverage according to claim 1, wherein an amount sprayed per use is 0.3 mL or more.

4. The beverage according to claim 1, wherein the aerosol type spraying container is a bag-on-valve (BOV).

5. The beverage according to claim 1, wherein a total content of monosaccharides and disaccharides, excluding sugar alcohols, is 20 g/L or less.

6. The beverage according to claim 1, comprising a flavoring.
